(19) United States
(12) Patent Application Publication
(10) Pub. No.: US 2025/0194588 A1
(43) Pub. Date: Jun. 19, 2025

(54) AGROCHEMICAL SUSPENSION OF SDHI AND/OR STROBILURIN FUNGICIDES

(71) Applicant: ADAMA MAKHTESHIM LTD., Beer-Sheva (IL)

(72) Inventors: Diana POLIAK, Beer-Sheva (IL); Anna PRAIZ, Beer-Sheva (IL); Viacheslav FIRER SLAVA, Beer-Sheva (IL)

(73) Assignee: ADAMA MAKHTESHIM LTD., Beer-Sheva (IL)

(21) Appl. No.: 18/844,535

(22) PCT Filed: Mar. 7, 2023
(86) PCT No.: PCT/IL2023/050239

§ 371 Date: Sep. 6, 2024

Related U.S. Application Data
(60) Provisional application No. 63/317,124, filed on Mar. 7, 2022.

(51) Int. Cl. A01N 25/04; A01N 25/22; A01N 43/54; A01N 43/56; A01P 3/00

(52) U.S. Cl. CPC A01N 25/04; A01N 25/22; A01N 43/54; A01N 43/56; A01P 3/00

(57) ABSTRACT

The present invention relates to a stable concentrated agrochemical suspension comprising SDHI fungicide and/or strobilurin fungicide and stabilizing component comprising a) at least one naphthalenesulfonate condensate; b) at least one fatty alcohol alkoxylate; c) at least one block copolymer; d) optionally at least one organomodified polysiloxane; 3) water; and use of said concentrated suspension as a fungicide in agrochemical field.

### RELATED APPLICATION/S

This application claims the benefit of priority of U.S. Provisional Patent Application No. 63/317,124 filed on Mar. 7, 2022, the contents of which are incorporated herein by reference in their entirety.

### FIELD OF INVENTION

The present invention relates to a stable concentrated suspension containing SDHI fungicide and/or strobilurin fungicide and use of said concentrated suspension as a fungicide in agrochemical field.

### SUMMARY

The present invention provides a concentrated agrochemical suspension comprising: 1) one or more active ingredients selected among SDHI fungicides and/or strobilurin fungicides; 2) stabilizing component comprising a) at least one naphthalenesulfonate condensate; b) at least one fatty alcohol alkoxylate; c) at least one block copolymer; d) optionally at least one organomodified polysiloxane; 3) water.

In addition, the present invention is directed to a concentrated agrochemical suspension comprising: 1) one or more active ingredients selected among SDHI fungicides and/or strobilurin fungicides; 2) stabilizing component comprising a) at least one naphthalenesulfonate condensate; b) at least one fatty alcohol alkoxylate; c) at least one block copolymer; d) at least one organomodified polysiloxane; 3) water.

In addition, the present invention provides a concentrated agrochemical suspension comprising: 1) at least one SDHI fungicide in an amount within the range from about 1% to about 70% by weight, more preferably from about 5% to about 60% by weight, and at least one strobilurin fungicide in an amount within the range from about 1% to about 70% by weight, more preferably from about 5% to about 60% by weight with respect to the weight of said concentrated agrochemical suspension; 2) stabilizing component comprising a) at least one naphthalenesulfonate condensate; b) at least one fatty alcohol alkoxylate; c) at least one block copolymer; d) optionally at least one organomodified polysiloxane; 3) water.

Additional aspect of the present invention is the use of stabilizing component consisting of: a) at least one organomodified polysiloxane; a) at least one naphthalenesulfonate condensate; b) at least one fatty alcohol alkoxylate; c) at least one block copolymer; d) optionally at least one organomodified polysiloxane for increasing the efficacy of SDHI fungicides and/or strobilurin fungicides.

In addition, the present invention is directed to the use of the stabilizing component consisting of: a) at least one organomodified polysiloxane; a) at least one naphthalenesulfonate condensate; b) at least one fatty alcohol alkoxylate; c) at least one block copolymer; d) at least one organomodified polysiloxane for increasing the efficacy of SDHI fungicides and/or strobilurin fungicides.

The present invention provides a method of control of crystal growth of SDHI fungicide in agrochemical suspension by addition of: a) at least one naphthalenesulfonate condensate; b) at least one block copolymer c) at least one organomodified polysiloxane to said agrochemical suspension comprising SDHI fungicide.

Furthermore, the present invention provides a method for controlling phytopathogenic fungi in a crop plant pests comprising applying an effective amount of the composition comprising: 1) one or more active ingredients selected among SDHI fungicides and/or strobilurin fungicides; 2) concentrate stabilizing component comprising a) at least one naphthalenesulfonate condensate; b) at least one fatty alcohol alkoxylate; c) at least one block copolymer; d) optionally at least one organomodified polysiloxane; 3) water.

### BACKGROUND

Among other known fungicides, succinate dehydrogenase inhibitor (SDHI) fungicides and strobilurin fungicides are extensively used for the control of a wide range of fungal diseases. Large number of agrochemical formulations containing succinate dehydrogenase inhibitors or strobilurins as active ingredients are known in the art for use in the agrochemical field.

According to the common practice agrochemical active ingredients may be provided to the user in the form of different formulations, such as liquid suspension concentrates, suspoemulsions, soluble concentrates, emulsifiable concentrates and/or solid compositions such as soluble granules, dispersible granules, powders, etc.

Liquid suspension concentrates formulations are preferred due to the fact that the active ingredients included in said formulations are in the form of solid particles and no presence of considerable amounts of heavy organic solvents such as aromatic hydrocarbons, chlorinated hydrocarbons, sulfoxides, amides, etc. which are known for their poor toxicological and/or ecotoxicological profile is required. In addition, suspension concentrates have advantage compared to other types of formulations such as dustless, easy to use when diluted in water at any desired ratio, low phytotoxicity risk and higher overall field effectiveness. However, in case of suspension concentrates, chemical phenomena of “Ostwald ripening” or “crystal growth” is considered as mainly contributing to the lower efficacy of final composition. Crystal growth commonly observed in solid dispersed solutions and colloid suspensions, when small crystals or suspending particles dissolve in a bulk phase and after some period of time, said crystals or suspending particles precipitate onto larger crystals or particles aggregates. As a result, a need for increased dosage of the pesticide could be required, decreased shelf-life of the formulation, further difficulties in diluting and pouring the product expected, and final reduction of efficacy of the pesticide observed.

Based on the above, there is a continuing need to provide environmentally preferred fungicidal suspension concentrates, which provide improved bioefficacy for control of various pathogens.

### DESCRIPTION

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains. The following definitions are provided for clarity.

The term “a” or “an” as used herein includes the singular and the plural, unless specifically stated otherwise. Therefore, the terms “a,” “an,” or “at least one” can be used interchangeably in this application.

As used herein, the verb “comprise” as is used in this description and in the claims and its conjugations are used in its non-limiting sense to mean that items following the word are included, but items not specifically mentioned are not excluded.

As used herein, the term “about” when used in connection with a numerical value includes ±10% from the indicated value. In addition, all ranges directed to the same component or property herein are inclusive of the endpoints, are independently combinable, and include all intermediate points and ranges. It is understood that where a parameter range is provided, all integers within that range, and tenths thereof, are also provided by the invention.

As used herein, the term “effective amount” refers to an amount of the active component that is commercially recommended for use to control and/or prevent pest. The commercially recommended amount for each active component, often specified as application rates of the commercial formulation, may be found on the label accompanying the commercial formulation. The commercially recommended application rates of the commercial formulation may vary depending on factors such as the plant species and the pest to be controlled.

As used herein, the term “suspension concentrate composition” or “SC composition” refers to a composition also sometimes referred to as an “aqueous flowable” composition, which compositions are known in the art and include or consist of particles of solid active fungicide compound in suspension in water.

As used herein, the term “additive” refers to any substance that itself is not an active ingredient but is added to the composition. Examples of additives includes, but are not limited to, adjuvants, surfactants, emulsifiers, anti-freeze agents, antifoam agents, and preservatives.

As used herein, the term “stable” when used in connection with a composition means that the composition is physically stable and chemically stable. As used herein, the term “chemically stable” means that no significant decomposition of the active components was observed after at least 2 weeks of storage in a sealed package at a temperature of 54° C. As used herein, the term “physically stable” means that no significant sedimentation was observed after at least 2 weeks of storage in a sealed package at a temperature of 54° C. “Physically stable” may also refer to other parameters such as viscosity, density etc. which are a function of the ability of the suspension to remain in its original state.

Stability may be assessed according to test protocol established by the Collaborative International Pesticides Analytical Council Ltd. (CIPAC). Stability can be assessed under normal storage conditions which is after two years storage at room temperature. Stability can also be assessed under accelerated storage conditions which is after 2 weeks storage at 54° C. or after 8 weeks at 40° C. or after 12 weeks at 35° C. or after 2 weeks at 0° C. or after 2 weeks at −10° C.

Particle size is typically defined as a log-normal distribution with a median diameter or D90—that is 90% of the particles measured are less than the given value and 10% are greater than the given value. The term “particle size distribution” as used herein refers to the relative percentages by weight or volume of each of the different size fractions of a particulate matter. The term “D90”, as used herein refers to the 90% quantile of a particle size distribution. The term “D90” hence defines a size where 90 volume percent of the particles have sizes less than the value given.

The particle size distributions for the present application can be measured using laser light diffraction equipment or other types of equipment that are also suitable for particle size distribution determinations.

As used herein, the term “pest” includes, but is not limited to, unwanted phytopathogenic harmful fungi, unwanted insect, unwanted nematode, and weed.

As used herein, the term “pesticide” broadly refers to an agent that can be used to prevent, control and/or kill a pest. The term is understood to include but is not limited to fungicides, insecticides, nematicides, herbicides, acaricides, parasiticides or other control agents. For chemical classes and applications, as well as specific compounds of each class, see “The Pesticide Manual Thirteenth Edition” (British Crop Protection Council, Hampshire, U K, 2003), as well as “The e-Pesticide Manual, Version 3” (British Crop Protection Council, Hampshire, U K, 2003-04), the contents of each of which are incorporated herein by reference in their entirety.

As used herein, the term “locus” includes not only areas where the pest may already be developed, but also areas where pests have yet to emerge, and also to areas under cultivation. Locus includes the plant or crop and propagation material of the plant or crop. Locus also includes the area surrounding the plant or crop and the growing media of the plant or crop, such as soil and crop field.

As used herein the term “plant” or “crop” includes reference to whole plants, plant organs (e.g. leaves, stems, twigs, roots, trunks, limbs, shoots, fruits etc.), plant cells, or plant seeds. This term also encompasses plant crops such as fruits, spores, corms, bulbs, rhizomes, sprouts basal shoots, stolons, and buds and other parts of plants, including seedlings and young plants, which are to be transplanted after germination or after emergence from soil.

As used herein the term “ha” refers to hectare.

The aspects and embodiments of the present invention are described below.

The present invention provides a concentrated agrochemical suspension comprising: 1) one or more active ingredients selected among SDHI fungicides and/or strobilurin fungicides; 2) stabilizing component comprising a) at least one naphthalenesulfonate condensate; b) at least one fatty alcohol alkoxylate; c) at least one block copolymer; d) optionally at least one organomodified polysiloxane; 3) water.

In an embodiment, the present invention provides a concentrated agrochemical suspension comprising: 1) one or more active ingredients selected among SDHI fungicides and/or strobilurin fungicides; 2) stabilizing component comprising a) at least one naphthalenesulfonate condensate; b) at least one fatty alcohol alkoxylate; c) at least one block copolymer; d) at least one organomodified polysiloxane; 3) water.

In an embodiment the present invention provides a concentrated agrochemical suspension comprising: 1) at least one SDHI fungicide in an amount within the range from about 1% to 70% by weight, and/or at least one strobilurin fungicide in an amount within the range from about 1% to 70% by weight, with respect to the weight of said concentrated agrochemical suspension; 2) stabilizing component comprising a) at least one naphthalenesulfonate condensate; b) at least one fatty alcohol alkoxylate; c) at least one block copolymer; d) optionally at least one organomodified polysiloxane; 3) water.

According to another embodiment the present invention provides a concentrated agrochemical suspension comprising: 1) at least one SDHI fungicide in an amount within the range from about 1% to about 70% by weight, and/or at least one strobilurin fungicide in an amount within the range from about 1% to about 70% by weight, with respect to the weight of said concentrated agrochemical suspension; 2) concentrate stabilizing component comprising a) at least one naphthalenesulfonate condensate; b) at least one fatty alcohol alkoxylate; c) at least one block copolymer; d) at least one organomodified polysiloxane; 3) water.

In an embodiment, the SDH fungicides are selected from the group comprising benodanil, flutilanil, mepronil, isofetamid, fluopyram, fenfuram, carboxin, oxycarboxin, thifluzamide, benzovindiflupyr, bixafen, fluindapyr, fluxapyroxad, furametpyr, inpyrfluxam, isopyrazam, penflufen, penthiopyrad, sedaxane, isoflucypam, pydiflumetofen, boscalid, pyraziflumid and the mixtures thereof.

According to another embodiment the SDH fungicide is fluxapyroxad. In an embodiment the strobilurin fungicides are selected from the group comprising azoxystrobin, kresoxim-methyl, picoxystrobin, fluoxastrobin, oryzastrobin, dimoxystrobin, pyraclostrobin, trifloxystrobin and the mixtures thereof.

In another embodiment the strobilurin fungicide is azoxystrobin.

According to another embodiment the present invention provides the concentrated agrochemical suspension comprising: 1) at least one SDHI fungicide in an amount within the range from about 1% to about 70% by weight, more preferably from about 5% to about 60% by weight, and at least one strobilurin fungicide in an amount within the range from about 1% to about 70% by weight, more preferably from about 5% to about 60% by weight with respect to the weight of said concentrated agrochemical suspension; 2) stabilizing component comprising a) at least one naphthalenesulfonate condensate; b) at least one fatty alcohol alkoxylate; c) at least one block copolymer; d) optionally at least one organomodified polysiloxane; 3) water.

According to one embodiment, the present invention provides the concentrated agrochemical suspension comprising: 1) fluxapyroxad in an amount within the range from about 1% to about 70% by weight, more preferably from about 5% to about 60% by weight, and azoxystrobin in an amount within the range from about 1% to about 70% by weight, more preferably from about 5% to about 60% by weight with respect to the weight of said concentrated agrochemical suspension; 2) stabilizing component comprising a) at least one naphthalenesulfonate condensate; b) at least one fatty alcohol alkoxylate; c) at least one block copolymer; d) optionally at least one organomodified polysiloxane; 3) water.

According to one embodiment, the present invention provides the concentrated agrochemical suspension comprising: 1) fluxapyroxad in an amount within the range from about 1% to about 70% by weight, more preferably from about 5% to about 60% by weight, and azoxystrobin in an amount within the range from about 1% to about 70% by weight, more preferably from about 5% to about 60% by weight with respect to the weight of said concentrated agrochemical suspension; 2) stabilizing component comprising a) at least one naphthalenesulfonate condensate; b) at least one fatty alcohol alkoxylate; c) at least one block copolymer; d) at least one organomodified polysiloxane; 3) water.

In some embodiments, the amount of SDHI fungicide in the suspension concentrate (SC) composition is from about 1% to about 70% by weight, based on the total weight on the composition. In some embodiments, the amount of SDHI fungicide in the SC composition is from about 1% to about 30% by weight, based on the total weight on the composition. In some embodiments, the amount of SDHI fungicide in the SC composition is from about 1.5% to about 25% by weight, based on the total weight on the composition. In some embodiments, the amount of SDHI fungicide in the SC composition is from about 1.5% to about 20% by weight, based on the total weight on the composition. In some embodiments, the amount of SDHI fungicide in the SC composition is from about 1.8% to about 15% by weight, based on the total weight on the composition. In some embodiments, the amount of SDHI fungicide in the SC composition is from about 2% to about 10% by weight, based on the total weight on the composition. In some embodiments, the amount of SDHI fungicide in the SC composition is from about 5% to about 12% by weight, based on the total weight on the composition. In some embodiments, the amount of SDHI fungicide in the SC composition is about 10% by weight, based on the total weight on the composition.

In yet another embodiment, the SDHI fungicide is fluxapyroxad, and the amount of fluxapyroxad in the suspension concentrate (SC) composition is from about 1% to about 70% by weight, based on the total weight on the composition. In some embodiments, the amount of fluxapyroxad in the SC composition is from about 1% to about 30% by weight, based on the total weight on the composition. In some embodiments, the amount of fluxapyroxad in the SC composition is from about 1.5% to about 5% by weight, based on the total weight on the composition. In some embodiments, the amount of fluxapyroxad in the SC composition is from about 1.5% to about 20% by weight, based on the total weight on the composition. In some embodiments, the amount of fluxapyroxad in the SC composition is from about 1.8% to about 5% by weight, based on the total weight on the composition. In some embodiments, the amount of fluxapyroxad in the SC composition is from about 2% to about 10% by weight, based on the total weight on the composition. In some embodiments, the amount of fluxapyroxad in the SC composition is from about 5% to about 12% by weight, based on the total weight on the composition. In some embodiments, the amount of fluxapyroxad in the SC composition is about 10% by weight, based on the total weight on the composition.

In some embodiments, the amount of strobilurin fungicide in the suspension concentrate (SC) composition is from about 1% to about 70% by weight, based on the total weight on the composition. In some embodiments, the amount of strobilurin fungicide in the SC composition is from about 1% to about 50% by weight, based on the total weight on the composition. In some embodiments, the amount of strobilurin fungicide in the SC composition is from about 10% to about 40% by weight, based on the total weight on the composition. In some embodiments, the amount of strobilurin fungicide in the SC composition is from about 10% to about 40% by weight, based on the total weight on the composition. In some embodiments, the amount of strobilurin fungicide in the SC composition is from about 10% to about 25% by weight, based on the total weight on the composition. In some embodiments, the amount of strobilurin fungicide in the SC composition is from about 15% to about 18% by weight, based on the total weight on the composition. In some embodiments, the amount of strobilurin fungicide in the SC composition is about 16.5% by weight, based on the total weight on the composition.

In yet another embodiment, the strobilurin fungicide is azoxystrobin, and the amount of azoxystrobin in the suspension concentrate (SC) composition is from about 1% to about 70% by weight, based on the total weight on the composition. In some embodiments, the amount of azoxystrobin in the SC composition is from about 1% to about 50% by weight, based on the total weight on the composition. In some embodiments, the amount of azoxystrobin in the SC composition is from about 10% to about 40% by weight, based on the total weight on the composition. In some embodiments, the amount of azoxystrobin in the SC composition is from about 10% to about 40% by weight, based on the total weight on the composition. In some embodiments, the amount of azoxystrobin in the SC composition is from about 10% to about 25% by weight, based on the total weight on the composition. In some embodiments, the amount of azoxystrobin in the SC composition is from about 15% to about 18% by weight, based on the total weight on the composition. In some embodiments, the amount of azoxystrobin in the SC composition is about 16.5% by weight, based on the total weight on the composition.

In an embodiment, the naphthalenesulfonate condensates include, but are not limited to alkyl naphthalene formaldehyde condensate sulfonate of the formula:

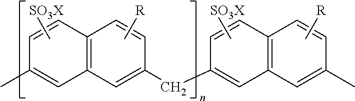

wherein
R is independently hydrogen, a C₁₋₁₅ straight or branched chain alkyl or alkenyl group; X is independently hydrogen, an alkali metal, an alkaline earth metal, ammonium, a mono-, di-, or tri-C₁₋₄ alkyl ammonium, or a mono-, di- or tri-C₁₋₄ hydroxyalkyl ammonium moiety.
n is from 1 to 25.
R groups can be present in any position on the naphthalene nucleus.

Suitable examples of naphthalene sulfonate condensates may include Morwet D-425, Morwet D-500 available from NOURYON, Tersperse 2020 available from Indroma and Surfom WG 8168 available from Oxiteno.

In an embodiment, the fatty alcohol alkoxylates include, but are not limited to those represented by Formula 1:

R¹—O-(AO)ₘ—R² (1),

in which
R¹ is straight-chain or branched alkyl or alkylene with from 4 to 32, preferably from
10 to 22, carbon atoms,
AO is an ethylene oxide radical, propylene oxide radical, butylene oxide radical, pen-tylene oxide radical, styrene oxide radical or mixtures of the abovementioned radicals in random or block sequence,
m is numbers from 1 to 30 and
R² is hydrogen or alkyl with from 1 to 4 carbon atoms.
   In an embodiment, the fatty alcohol alkoxylates are those represented by Formula 2:

R¹—O-(AO)ₘ—R³ (1),

in which
R¹ is straight-chain or branched alkyl with from 16 to 18 carbon atoms
AO is an ethylene oxide radical, propylene oxide radical, butylene oxide radical, pen-tylene oxide radical, styrene oxide radical or mixtures of the abovementioned radicals in random or block sequence,
m is numbers from 1 to 30 and
R³ is hydrogen.

Suitable examples of fatty alcohol alkoxylates may include ATPLUS 242-SO-(CQ), Atplus 245, Atplus MBA 1303 available from Croda, Plurafac LF types from BASF SE, Agnique BP 24-24, Agnique BP 24-36, Agnique BP 24-45, Agnique BP 24-54, Agnique BP24-52R from Cognis.

In an embodiment, the organomodified polysiloxanes include, but are not limited to polyalkylene-modified polymethylsiloxanes, polyether modified trisiloxanes, and the like. Suitable examples of organomodified polysiloxanes may include BreakThru® OE444, BreakThru® S240, available from Evonic Industries, Silwett® L77, and Silwett® 408 available from Momentive Performance Materials Inc.

The block copolymers of the present invention contain ethylene oxide (EO) and at least one other C₃-C₁₀ alkylene oxide, such as propylene oxide (PO), butylene oxide (BO) and the like. The block copolymers preferably are (EO)-(PO) block copolymers having a molecular weight ranging from 500 to 10,000, more preferred copolymers have a molecular weight of 1000 to 4000 and an EO content of 10 to 50% by weight. Suitable examples of block copolymers may include Toximul® 8320 available from Stepan (Northfield, Ill.), Termul® 5429 available from Huntsman International LLC (The Woodlands, Tex.), Tergitol™ XD available from Dow Chemical (Midland, Mich.), Ethylan™ NS 500LQ available from AkzoNobel, Emulsogen 3510 available from Clariant GmbH, or Atlas G 5000 available from Croda.

In some embodiments, the amount of naphthalenesulfonate condensate is from about 0.1% to about 20%, preferably from about 1% to about 10%, more preferably from about 3% to about 6% by weight based on the total weight on the composition.

In some embodiments, the amount of fatty alcohol alkoxylate is from about 0.1% to about 20%, preferably from about 1% to about 15%, more preferably from about 8% to about 10% by weight based on the total weight on the composition.

In some embodiments, the amount of block copolymer is from about 0.1% to about 20%, preferable from about 1% to about 10%, more preferably from about 2% to about 6% based on the total weight on the composition.

In some embodiments, the amount of organomodified polysiloxane is from about 0.1% to about 20%, preferably from about 1% to about 10%, more preferably from about 0.5% to about 2% based on the total weight on the composition.

All the compositions and/or combinations of the invention may comprise further additives such as emulsifiers, penetrants, wetting agents, spreading agents and/or retention agents. Suitable substances are all of those which can typically be used for this purpose in agrochemicals.

Additional suitable additives which may be present in all the compositions of the invention are defoamers, preservatives, antioxidants, dyes and inert fillers.

Suitable defoamers are all substances which can typically be used for this purpose in agrochemicals. Preference is given to silicone oils, silicone oil formulations, magnesium stearate, phosphinic acids and phosphonic acids. Examples are Silcolapse® 482 from Bluestar Silicones, Silfoam® SCI 132 from Wacker [dimethylsiloxanes and -silicones, CAS No. 63148-62-9], SAG 1538 or SAG 1572 from Momentive [dimethylsiloxanes and -silicones, CAS-Nr. 63148-62-9] or Fluowet® PL 80.

Possible preservatives are all substances which can typically be used for this purpose in agrochemicals. Suitable preservatives are, for example, formulations comprising 5-chloro-2-methyl-4-isothiazolin-3-one [CIT; CAS No. 26172-55-4], 2-methyl-4-isothiazolin-3-one [MIT, CAS No. 2682-204] or 1,2-benzisothiazol-3(2H)-one [BIT, CAS No. 2634-33-5]. Examples include Preventol® D7 (Lanxess), Kathon® CG/ICP (Rohm & Haas), Acticide® SPX (Thor GmbH) and Proxel® GXL (ArchChemicals).

Suitable antioxidants are all substances which can typically be used for this purpose in agrochemicals. Preference is given to butylhydroxytoluene [3,5-di-tert-butyl-4-hydroxytoluene, CAS No. 128-37-0] and citric acid.

Possible dyes are all substances which can typically be used for this purpose in agrochemicals. Examples include titanium dioxide, carbon black, zinc oxide, blue pigments, red pigments and Permanent Red FGR.

Suitable inert fillers are all substances which can typically be used for this purpose in agrochemicals and which do not function as thickeners. Preference is given to inorganic particles such as carbonates, silicates and oxides, and also organic substances such as urea-formaldehyde condensates. Examples include kaolin, rutile, silicon dioxide (“finely divided silica”), silica gel and natural and synthetic silicates, and additionally talc.

All the compositions and/or combinations of the invention can be applied in undiluted form or diluted with water. In general, they are diluted with at least one part w ater, preferably with 10 parts water and more preferably with at least 100 parts water, for example with 1 to 10000, preferably 10 to 5000 and more preferably with 50 to 24,000 parts water, based on one part of the formulation.

The present invention likewise provides suspension obtainable by mixing water with the liquid compositions of the invention. The mixing ratio of water to suspension concentrate may be in the range from 1500:1 to 1:1, preferably 500:1 to 10:1.

The dilution is achieved by pouring the suspension concentrates of the invention into the water. For rapid mixing of the concentrate with water, it is customary to use agitation, for example stirring. However, agitation is generally unnecessary. Even though the temperature for the dilution operation is an uncritical factor, dilutions are typically conducted at temperatures in the range from 00° C. to 50° C., especially at 10° C. to 30° C. or at ambient temperature.

The water used for dilution is generally tap water, surface water or water from a well. The water may, however, already contain water soluble or finely dispersed compounds which are used in crop protection, for instance nutrients, fertilizers or pesticides. It is possible to add various kinds of oils, wetting agents, adjuvants, fertilizers or micronutrients and further pesticides (e.g. herbicides, insecticides, fungicides, growth regulators, safeners) to the suspension of the invention in the form of a premix or, if appropriate, not until shortly before use (tank-mix). These may be added to the compositions of the invention in a weight ratio of 1:100 to 100:1, preferably 1:10 to 10:1.

The user will apply the compositions of the invention typically from a pre-dosing system, a backpack sprayer, a spraying tank, a spraying aircraft or an irrigation system; the compositions of the invention is typically diluted to the desired deployment concentration with water, buffer and/or further auxiliaries, which affords the ready-to-use spray liquid or agrochemical composition of the invention. Typically, 10 to 2000 liters, preferably 50 to 400 liters, of the ready-to-use spray liquid are deployed per hectare of useful agricultural area.

The generally diluted compositions of the invention are applied mainly by spraying, especially spraying of the leaves. Application can be conducted by spraying techniques known to those skilled in the art, for example using water as carrier and amounts of spray liquid of about 50 to 1000 liters per hectare, for example from 100 to 200 liters per hectare.

In an embodiment, the concentrated agrochemical suspensions of this invention can be applied to the plants or their environment with other active substances. These active substances (a) can be either fertilizers or any agents which influence plant growth. However, they can also be selective herbicides, insecticides, fungicides, bactericides, nematicides, algicides, molluscicides, rodenticides, virucides, compounds inducing resistance into plants, biological control agents such as viruses, bacteria, nematodes, fungi and other microorganisms, repellents of birds and animals, and plant growth regulators, or mixtures of several of these preparations.

In another embodiment, the concentrated agrochemical suspensions of this invention include at least one additional fungicide selected from one of the following classes of compounds: triazoles, imidazoles, copper salts, phthalimides, dithiocarbamates, chloronitriles, acylalanines.

Examples of additional fungicides belonging to the class of triazoles that can be present in the concentrated suspension are azaconazole, bitertanol, bromuconazole, cyproconazole, diphenoconazole, epoxyconazole, fenbuconazole, fluquinconazole, flusilazole, flutriafol, hexaconazole, imazalil, ipconazole, ipfentrifluconazole, mefentrifluconazole, metconazole, myclobutanil, penconazole, propiconazole, prochloraz, prothioconazole, simeconazole, tebuconazole, triadimefon, triadimenol, triflumizole, triticonazole.

Examples of additional fungicides belonging to the class of imidazoles that can be present in the concentrated suspension are: imazalil, oxpoconazole, pefurazoate, prochloraz, triflumizole.

Examples of additional fungicides belonging to the class of copper salts that can be present in the concentrated suspension are copper hydroxide, tetracopper oxychloride, Bordeaux mixture (copper sulphate neutralized with calcium hydroxide), copper sulphate, copper pentahydrate, alone or in a mixture thereof.

Examples of additional fungicides belonging to the class of phthalimides that can be used in the concentrated suspension are: folpet, captan, captafol.

Examples of additional fungicides belonging to the class of dithiocarbamates that can be used in the concentrated suspension are: febram, maneb, mancozeb, metiram, propineb, thiram, zinc thiazole, zineb, ziram.

An example of additional fungicides belonging to the class of chloronitriles that can be used in the concentrated suspension is chlorothalonil.

Examples of additional fungicides belonging to the class of acylalanines that can be used in the concentrated suspension are: benalaxyl, benalaxyl-M, furalaxyl, metalaxyl, metalaxyl-M.

When the concentrated suspension contains one or more additional fungicides, their overall concentration is preferably in the range from about 1% to about 40% by weight, with respect to the total weight of said concentrated suspension.

The present invention provides a method for controlling pathogens of fungal diseases in a crop plant pests comprising applying an effective amount of the composition comprising: 1) one or more active ingredients selected among SDHI fungicides and/or strobilurin fungicides; 2) stabilizing component comprising a) at least one naphthalenesulfonate condensate; b) at least one fatty alcohol alkoxylate; c) at least one block copolymer; d) optionally at least one organomodified polysiloxane; 3) water.

In another embodiment, the present invention provides a method for controlling pathogens of fungal diseases in a crop plant pests comprising applying an effective amount of the composition comprising: 1) one or more active ingredients selected among SDHI fungicides and/or strobilurin fungicides; 2) stabilizing component comprising a) at least one naphthalenesulfonate condensate; b) at least one fatty alcohol alkoxylate; c) at least one block copolymer; d) at least one organomodified polysiloxane; 3) water.

Non-limiting examples of pathogens of fungal diseases which may be treated in accordance with the invention include: diseases caused by powdery mildew pathogens, for example Blumeria species, for example Blumeria graminis, Podosphaera species, for example Podosphaera leucotricha, Sphaerotheca species, for example Sphaerotheca fuliginea, Uncinula species, for example Uncinula necator, for example Erysiphe species; diseases caused by rust disease pathogens, for example Gymnosporangium species, for example Gymnosporangium sabinae; Hemileia species, for example Hemileia vastatrix; Phakopsora species, for example Phakopsora pachyrhizi or Phakopsora meibomiae Puccinia species, for example Puccinia recondita, Puccinia graminis oder Puccinia striif ormis, Uromyces species, for example Uromyces app endiculatus, diseases caused by pathogens from the group of the Oomycetes, for example Albugo species, for example Albugo candida, Bremia species, for example Bremia laciucaer, Peronospora species, for example Peronospora pisi or P. brassicaer, Phytophthora species, for example Phytophthora infestans, Plasmopara species, for example Plasmopara viticola, Pseudoperonospora species, for example Pseudoperonospora humuli or Pseudoperonospora cubensis, Pythium species, for example Pythium ultimunv, leaf blotch diseases and leaf wilt diseases caused, for example, by Alternaria species, for example Alternaria solanv, Cercospora species, for example Cercospora beticola, Cladiosporium species, for example Cladiosporium cucumerinunr, Cochliobolus species, for example Cochliobolus sativus (conidial form: Drechslera, syn: Helminthosporium) or Cochliobolus miyabeanus, Colletotrichum species, for example Colletotrichum lindemuthaniunv, Corynespora species, for example Corynespora cassiicola, Cycloconium species, for example Cycloconium oleaginunv, Diaporthe species, for example Diaporthe citrv, Elsinoe species, for example Elsinoe fawcettii, Gloeosporium species, for example Gloeosporium laeticolor, Glomerella species, for example Glomerella cingulata, Guignardia species, for example Guignardia bidwellv, Leptosphaeria species, for example Leptosphaeria maculans, Magnaporthe species, for example Magnaporthe grisea, Microdochium species, for example Microdochium nivaler, Mycosphaerella species, for example Mycosphaerella graminicola (also known as Septoria tritici), Mycosphaerella arachidicola or Mycosphaerella fijiens, Phaeosphaeria species, for example Phaeosphaeria nodorunr, Pyrenophora species, for example Pyrenophora teres or Pyrenophora tritici repenth, Ramularia species, for example Ramularia collo-cygni or Ramularia areola, Rhynchosporium species, for example Rhynchosporium secalis, Septoria species, for example Septoria apii or Septoria lycopersicv, Stagonospora species, for example Stagonospora nodorunr, Typhula species, for example Typhula incarnata, Venturia species, for example Venturia inaequal, root and stem diseases caused, for example, by Corticium species, for example Corticium graminearum, Fusarium species, for example Fusarium oxysporum\Gaeumannomyces species, for example Gaeumannomyces graminis, Plasmodiophora species, for example Plasmodiophora brassica, Rhizoctonia species, for example Rhizoctonia solani, Sarocladium species, for example Sarocladium oryzae; Sclerotium species, for example Sclerotium oryzae, Tapesia species, for example Tapesia acuf ormis, Thielaviopsis species, for example Thielaviopsis basicola, ear and panicle diseases (including corn cobs) caused, for example, by Alternaria species, for example Alternaria spp.; Aspergillus species, for example Aspergillus flavus, Cladosporium species, for example Cladosporium cladosporioides, Claviceps species, for example Claviceps purpurea, Fusarium species, for example Fusarium culmorum, Gibberella species, for example Gibberella zeae Monographella species, for example Monographella nivalis, Stagnospora species, for example Stagnospora nodorunr, diseases caused by smut fungi, for example Sphacelotheca species, for example Sphacelotheca reiliana, Tilletia species, for example Tilletia caries or Tilletia controversy, Urocystis species, for example Urocystis occulta, Ustilago species, for example Ustilago nuda, fruit rot caused, for example, by Aspergillus species, for example Aspergillus flavus, Botrytis species, for example Botrytis cinerea, Monilinia species, for example Monilinia Iaχa, Penicillium species, for example Penicillium expansum or Penicillium purpurogenum, Rhizopus species, for example Rhizopus stolonifer, Sclerotinia species, for example Sclerotinia sclerotiorum, Verticillium species, for example Verticillium alboatrum, seed- and soil-borne rot and wilt diseases, and also diseases of seedlings, caused, for example, by Alternaria species, for example Alternaria brasside ola Aphanomyces species, for example Aphanomyces euteiches, Ascochyta species, for example Ascochyta lends, Aspergillus species, or example Aspergillus flavus, Cladosporium species, for example Cladosporium herbarum, Cochliobolus species, for example Cochliobolus sativus (conidial forme Drechslera, Bipolaris Syn: Helminthosp orium), Colletotrichum species, for example Colletotrichum coccodes, Fusarium species, for example Fusarium culmorum, Gibberella species, for example Gibberella zeae Macrophomina species, for example Macrophomina phaseolina, Microdochium species, for example Microdochium nivale, Monographella species, for example Monographella nivalis, Penicillium species, for example Penicillium expansum, Phoma species, for example Phoma lingam, Phomopsis species, for example Phomopsis soae Phytophthora species, for example Phytophthora cactorum, Pyrenophora species, for example Pyrenophora graminea, Pyricularia species, for example Pyricularia oryzae, Pythium species, for example Pythium ultimum, Rhizoctonia species, for example Rhizoctonia solanv, Rhizopus species, for example Rhizopus oryzae; Sclerotium species, for example Sclerotium rolfsii, Septoria species, for example Septoria nodorum, Typhula species, for example Typhula incarnata, Verticillium species, for example Verticillium dahliae, cancers, galls and witches' broom caused, for example, by Nectria species, for example Nectria galligena, wilt diseases caused, for example, by Verticillium species, for example Verticillium longisporum, Fusarium species, for example Fusarium oxysporurrv, deformations of leaves, flowers and fruits caused, for example, by Exobasidium species, for example Exobasidium vexans, Taphrina species, for example Taphrina deformans, degenerative diseases in woody plants, caused, for example, by Esca species, for example Phaeomoniella chlamydospora, Phaeoacremonium aleophilum or Fomitiporiamediterranean Ganoderma species, for example Ganoderma boninense, diseases of plant tubers caused, for example, by Rhizoctonia species, for example Rhizoctonia solanv, Helminthosporium species, for example Helminthosporium solanv, diseases caused by bacterial pathogens, for example Xanthomonas species, for example Xanthomonas campestris pv. oryzae, Pseudomonas species, for example Pseudomonas syringae pv. lachrymans, Erwinia species, for example Erwinia amylovora, Liberibacter species, for example Liberibacter asiaticus, Xyella species, for example Xylella fastidiosa, Ralstonia species, for example Ralstonia solanacearum, Dickeya species, for example Dickeya solanv, Clavibacter species, for example Clavibacter michiganensis, Streptomyces species, for example Streptomyces scabies. diseases of soya beans: fungal diseases on leaves, stems, pods and seeds caused, for example, by Alternaria leaf spot (Alternaria spec atrans tenuissima), Anthracnose (Colletotrichum gloeosporoides dematium var. truncatum), brown spot (Septoria glycines), cercospora leaf spot and blight (Cercospora kikuchii), choanephora leaf blight (Choanephora infundibulifera trispora (Syn.j), dactuliophora leaf spot (Dactuliophora glycines), downy mildew (Peronospora manshurica), drechslera blight (Drechslera glycini), frogeye leaf spot (Cercospora sojina), leptosphaerulina leaf spot (Leptosphaerulina trifolii), phyllostica leaf spot (Phyllosticta sojaecola), pod and stem blight (Phomopsis sojae), powdery mildew (Microsphaera diffusa), pyrenochaeta leaf spot (Pyrenochaeta glycines), rhizoctonia aerial, foliage, and web blight (Rhizoctonia solani), mst (Phakopsora pachyrhizi, Phakopsora meibomiae), scab (Sphaceloma glycines), stemphylium leaf blight (Stemphylium botryosum), sudden death syndrome (Fusarium virguliforme), target spot (Corynespora cassiicola). Fungal diseases on roots and the stem base caused, for example, by black root rot (Calonectria crotalariae), charcoal rot (Macrophomina phaseolina), fusarium blight or wilt, root rot, and pod and collar rot (Fusarium oxysporum, Fusarium orthoceras, Fusarium semitectum, Fusarium equiseti), mycoleptodiscus root rot (Mycoleptodiscus terrestris), neocosmospora (Neocosmospora vasinfecta), pod and stem blight (Diaporthe phaseolorum), stem canker (Diaporthe phaseolorum var. caulivora), phytophthora rot (Phytophthora megasperma), brown stem rot (Phialophora gregata), pythiumrot (Pythium aphanidermatum, Pythium irregulare, Pythium debaryanum, Pythium myriotylum, Pythium ultimum), rhizoctonia root rot, stem decay, and damping-off (Rhizoctonia solani), sclerotinia stem decay (Sclerotinia sclerotiorum), sclerotinia southern blight (Sclerotinia rolfsii), thielaviopsis root rot (Thielaviopsis basicola). In some embodiments, the phytopathogenic harmful fungi is selected from Septoria species, Fusarium species, Puccinia species, Erisyphe species, Drechslera species, Ramularia species, Mycosphaerella species and Rhynchosporium species.

In some embodiments, the phytopathogenic harmful fungi is selected from Puccinia recondita, Septoria tritici, Fusarium culmorum, Pyrenophora teres, Rhynchosporium secalis and Rhizoctonia solani.

In some embodiments, the crop is selected from the group consisting of cotton, rice, flax, grapevines, fruit, vegetables, such as Rosaceae sp. (for example pome fruit such as apples and pears, but also stone fruit such as apricots, cherries, almonds and peaches, and berry fruits such as strawberries), Ribesioidae sp., Juglandaceae sp., Betulaceae sp., Anacardiaceae sp., Fagaceae sp., Moraceae sp., Oleaceae sp., Actinidaceae sp., Lauraceae sp., Musaceae sp. (for example banana trees and plantations), Rubiaceae sp. (for example coffee), Theaceae sp., Sterculiceae sp., Rutaceae sp. (for example lemons, organs and grapefruit); Solanaceae sp. (for example tomatoes), Liliaceae sp., Asteraceae sp. (for example lettuce), Umbelliferae sp., Cruciferae sp., Chenopodiaceae sp., Cucurbitaceae sp. (for example cucumbers), Alliaceae sp. (for example leeks, onions), Papilionaceae sp. (for example peas); main crop plants such as Gramineae sp. (for example maize, turfgrass, cereals such as wheat, rye, rice, barley, oats, sorghum/millet and triticale), Asteraceae sp. (for example sunflowers), Brassicaceae sp. (for example white cabbage, red cabbage, broccoli, cauliflower, Brussels sprouts, Pak Choi, kohlrabi, radishes, and rapeseed, mustard, horseradish and cress), Fabacae sp. (for example beans, peanuts), Papilionaceae sp. (for example soya beans), Solanaceae sp. (for example potatoes), Chenopodiaceae sp. (for example sugar beet, fodder beet, chard, beetroot); sugarcane, poppies, olives, coconuts, cocoa, tobacco and useful plants and ornamental plants in gardens and forests; and genetically modified varieties of each of these plants, and the seeds of these plants. In a preferred embodiment, the crop is selected from the group consisting of rice, grapevines, vegetables.

In some embodiments, the composition of the present invention is applied in an amount from about 0.1 L/ha to about 2 L/ha. In some embodiments, the composition is applied in an amount from about 0.4 L/ha to about 1 L/ha.

In some embodiments, the composition is applied in an amount from about 20 g/ha of SDHI fungicide to about 500 g/ha of SDHI fungicide. In some embodiments, the composition is applied in an amount from about 100 g/ha of t SDHI fungicide to about 250 g/ha of SDHI fungicide.

In some embodiments, the composition is applied in an amount from about 20 g/ha of strobilurin fungicide to about 500 g/ha of strobilurin fungicide. In some embodiments, the composition is applied in an amount from about 100 g/ha of strobilurin fungicide to about 250 g/ha of strobilurin fungicide.

In some embodiments, the composition is applied in an amount from about 20 g/ha of fluxapyroxad to about 500 g/ha of fluxapyroxad. In some embodiments, the composition is applied in an amount from about 100 g/ha of fluxapyroxad to about 250 g/ha of fluxapyroxad.

In some embodiments, the composition is applied in an amount from about 20 g/ha of azoxystrobin to about 500 g/ha of azoxystrobin. In some embodiments, the composition is applied in an amount from about 100 g/ha of azoxystrobin to about 250 g/ha of azoxystrobin.

In an embodiment, the present invention provides the use of stabilizing component consisting of: a) at least one naphthalenesulfonate condensate; b) at least one fatty alcohol alkoxylate; c) at least one block copolymer; d) optionally at least one organomodified polysiloxane for increasing the efficacy of SDHI fungicides and/or strobilurin fungicides.

Preferably, the SDHI fungicide is fluxapyroxad, and the strobilurin fungicide is azoxystrobin.

In an embodiment, the present invention provides the use of the stabilizing component consisting of: a) at least one naphthalenesulfonate condensate; b) at least one fatty alcohol alkoxylate; c) at least one block copolymer; d) at least one organomodified polysiloxane for increasing the efficacy of SDHI fungicides and/or strobilurin fungicides.

In preferred embodiment said stabilizing component consisting of: a) from about 0.1% to about 20% of at least one naphthalenesulfonate condensate by weight based on the total weight on the composition; b) from about 0.1% to about 20% of at least one fatty alcohol alkoxylate by weight based on the total weight on the composition; c) from about 0.1% to about 20% of at least one block copolymer by weight based on the total weight on the composition; d) from about 0.1% to about 20% of at least one organomodified polysiloxane by weight based on the total weight on the composition.

Preferably, the SDHI fungicide is fluxapyroxad, and the strobilurin fungicide is azoxystrobin.

In an embodiment, the present invention provides a method of control of crystal growth of SDHI fungicide in agrochemical suspension by addition of: a) at least one naphthalenesulfonate condensate; b) at least one block copolymer c) at least one organomodified polysiloxane to said agrochemical suspension comprising SDHI fungicide.

Preferably, the SDHI fungicide is fluxapyroxad.

In an embodiment, the present invention provides the use of the stabilizing component consisting of; a) at least one naphthalenesulfonate condensate; b) at least one fatty alcohol alkoxylate; c) at least one block copolymer; d) optionally at least one organomodified polysiloxane for reducing the phytotoxicity of the concentrated agrochemical suspension comprising SDHI fungicides and/or strobilurin fungicides. Preferably, the SDHI fungicide is fluxapyroxad, and the strobilurin fungicide is azoxystrobin.

Examples are provided below to impede a more complete understanding of the present subject matter. The following examples illustrate the exemplary modes of making and practicing the present invention. However, the scope of the present invention is not limited to specific embodiments disclosed in these Examples, which are for purposes of illustration only. Other examples will be apparently constructed by one skilled in the art from consideration of the specification embodiments and examples.

### EXPERIMENTAL PART

### Example 1: Composition A and Preparation Thereof

In this example, a suspension concentrate (SC) containing 180 g/L of Azoxystrobin and 108 g/L Fluxapyroxad (Composition A) is represented in Table 1 below.

TABLE 1
Composition A:

| | % by weight of |
|---|---|
| Component | total composition |
| Azoxystrobin tech. CAS 131860-33-8 | 16.36 |
| Fluxapyroxad tech. CAS 907204-31-3 | 9.82 |
| AG-RH 23 (Ametech) | 0.19 |
| ATPLUS ® 242-SO-(CQ) (Croda) | 10.0 |
| Morwet ® D-500 (Akzo Nobel) | 3.0 |
| sodium salt of naphtalene sulfonate | |
| condensate blend with block copolymer | |
| Propylene glycol (Ineos) | 5.0 |
| Proxel ® GXL (Lonza) | 0.02 |
| SAG ® 1572 (Momentive Performance) | 0.4 |
| Silwet ® L77 (Momentive Performance) | 0.5 |
| Soft water | Up to 100% |

The Composition A shown in Table 1 is prepared by charging soft water (targeting 50% solids during milling), Silwet L-77, Propylene glycol, Morwet D-500 and mixing all components until a clear solution is obtained. After that half of the total amount of antifoam SAG® 1572 (0.2% by weight of total composition) was added to the solution and the obtained mixture mixed. Then Fluxapyroxad tech. was charged and the mixture underwent high shear, until a homogeneous suspension was obtained. After that, Azoxystrobin tech. was charged and the mixture underwent high shear, until a homogeneous suspension was obtained. The obtained suspension was milled and the rest half of total amount of SAG® 1572 was added and mixed (0.2% by weight of total composition). The preparation was completed by addition of the rest of additives and the remaining amount of soft water.

### Example 2

Comparative suspension concentrates (SC) Compositions B, C, D were prepared similarly to the procedure shown in Example 1. Table 2 summarizes the content of Compositions B, C, D.

TABLE 2

| Composition B | | Composition C | | Composition D | |
|---|---|---|---|---|---|
| | % by | | % by | | % by |
| | weight of | | weight of | | weight of |
| | total | | total | | total |
| Ingredient | composition | Ingredient | composition | Ingredient | composition |
| Azoxystrobin | 16.21 | Azoxystrobin tech. | 16.36 | Azoxystrobin | 16.36 |
| tech. (A.I. as | | (A.I. as 100%) | | tech. (A.I. as | |
| 100%) | | CAS 131860-33-8 | | 100%) | |
| CAS 131860-33-8 | | | | CAS 131860-33-8 | |
| Fluxapyroxad | 9.73 | Fluxapyroxad tech. | 9.82 | Fluxapyroxad | 9.82 |
| tech. (A.I. as | | (A.I. as 100%) | | tech. (A.I. as | |
| 100%) | | CAS 907204-31-3 | | 100%) | |
| CAS 907204-31-3 | | | | CAS 907204-31-3 | |
| AG-RH 23 | 0.29 | % AG-RH 23 + 0.2% | 9.78 | % AG-RH | 9.78 |
| (Ametech) | | Proxel ® GXL in water | | 23 + 0.2% | |
| | | | | Proxel ® | |
| | | | | GXL in water | |
| Morwet ® D- | 4.77 | ATPLUS ® 242-SO-(CQ) | 10.0 | ATPLUS ® | 10.0 |
| 500 (Akzo | | (Croda) | | 242-SO-(CQ) | |
| Nobel) | | | | (Croda) | |
| sodium salt | | | | | |
| of naphtalene | | | | | |
| sulfonate | | | | | |
| condensate | | | | | |
| blend with | | | | | |
| block | | | | | |
| copolymer | | | | | |
| Propylene | 4.91 | Morwet ® D-425(Akzo | 3.0 | Morwet ® D- | 3.0 |
| glycol | | Nobel) | | 500 (Akzo | |
| (Ineos) | | Alkylnaphthalenesulfonic | | Nobel) | |
| | | acid, polymer with | | sodium salt | |
| | | formaldehyde, sodium | | of naphtalene | |
| | | salt | | sulfonate | |
| | | | | condensate | |
| | | | | blend with | |
| | | | | block | |
| | | | | copolymer | |
| Proxel ® | 0.03 | Propylene glycol (Ineos) | 5.0 | Propylene | 5.0 |
| GXL (Lonza) | | | | glycol | |
| | | | | (Ineos) | |
| SAG ® 1572 | 0.39 | SAG ® 1572 (Momentive | 0.40 | SAG ® 1572 | 0.40 |
| (Momentive | | Performance) | | (Momentive | |
| Performance) | | | | Performance) | |
| Silwet ® L77 | 0.49 | Silwet ® L77 | 0.50 | | |
| (Momentive | | (Momentive | | | |
| Performance) | | Performance) | | | |
| Soft water | Up to 100% | Soft water | Up to 100% | Soft water | Up to 100% |

### Example 3: Efficacy Against Black Scurf (Rhizoctonia solani) on Rice

Compositions B, C, D as represented in Table 2 were used to illustrate the enhanced efficacy of inventive composition exemplified as Composition A.

The trials were conducted as pot trials under controlled conditions in a complete randomized block design with 4 replicates to evaluate efficacy against Black Scurf (Rhizoctonia solani) on rice (Vialone nano, variety). All tested compositions were applied at 95 g ai/ha with a boom sprayer.

The plant foliage was assessed at 23 to 37 days after last application. In the experiments the pest incidence and pest severity were assessed. As shown in Table 3, 4 below.

TABLE 3
% Efficacy incidence

| Treatment | Description | Rate | 23 DA-A | 37 DA-A |
|---|---|---|---|---|
| 1 | Untreated check | | 0.0 | 0.0 |
| 2 | Composition B | 95 g a.i./ha | 79.2 | 43.5 |
| 3 | Composition A | 95 g a.i./ha | 93.8 | 59.8 |
| 4 | Composition C | 95 g a.i./ha | 66.7 | 57.3 |
| 5 | Composition D | 95 g a.i./ha | 31.3 | 30.1 |

TABLE 4
% Efficacy severity

| Treatment | Description | Rate | 23 DA-A | 37 DA-A |
|---|---|---|---|---|
| 1 | Untreated check | | 0.0 | 0.0 |
| 2 | Composition B | 95 g a.i./ha | 94.6 | 78.6 |
| 3 | Composition A | 95 g a.i./ha | 96.7 | 90.9 |
| 4 | Composition C | 95 g a.i./ha | 87.7 | 89.8 |
| 5 | Composition D | 95 g a.i./ha | 71.1 | 46.6 |

The results in Tables 3 and 4 clearly show that Composition A brings an added value in terms of efficacy towards Compositions B, C, D.

### Example 4

Tank mix of commercially available solo SC composition of 300 g/L Fluxapyroxad named Sercadis® (BASF) with commercially available solo SC composition of 250 g/L Azoxystrobin named Amistar® (Syngenta) used for comparative efficacy studies represented below.

The trials were conducted as outdoor field trials in a complete randomized block design with 4 replicates to evaluate efficacy against Black Scurf (Rhizoctonia solani) on rice (Dai Thom 8, variety). All tested compositions were applied at 144 g ai/ha with a boom sprayer

The plant foliage was assessed at 0, 7, 14, and 21 days after last application and at harvest. In the experiments the pest incidence, severity, yield and grain quality were assessed as shown in Tables 5, 6, 7, 8 below.

TABLE 5
Disease incidence (%) of sheath blight

| | | | | 14 | 21 | |
|---|---|---|---|---|---|---|
| Treatment | Dose | 0 DAA | 7 DAA | DAA | DAA | harvest |
| Untreated | — | 28.6 | 26.8 | 26.7 | 27.1 | 31.3 |
| Composition A | 0.5 | 11.5 | 9.7 | 10.4 | 11.4 | 13.9 |
| Sercadis ® + | 0.18 + | 16.6 | 15.7 | 16.2 | 17.9 | 19 |
| Amistar ® | 0.36 | | | | | |

TABLE 6
Disease severity (%) of sheath blight

| | | | | 14 | 21 | |
|---|---|---|---|---|---|---|
| Treatment | Dose | 0 DAA | 7 DAA | DAA | DAA | harvest |
| Untreated | — | 27.6 | 27.3 | 40.3 | 46.5 | 59.3 |
| Composition A | 0.5 | 7.5 | 5.5 | 5.3 | 3.6 | 2.9 |
| Sercadis ® + | 0.18 + | 10.6 | 13.3 | 13.7 | 13.9 | 13.3 |
| Amistar ® | 0.36 | | | | | |

TABLE 7
Efficacy in % (severity) of sheath blight

| | | | 14 | 21 | |
|---|---|---|---|---|---|
| Treatment | Dose | 7 DAA | DAA | DAA | harvest |
| Untreated | — | — | — | — | — |
| Composition A | 0.5 | 74 | 86 | 92 | 95 |
| Sercadis ® + | 0.18 + | 64 | 64 | 69 | 78 |
| Amistar ® | 0.36 | | | | |

TABLE 8

| | | | Grain quality in % | | |
|---|---|---|---|---|---|
| Yield in gram /m² | | | filled | dirty | unfilled |
| Treatment | Dose | Yield | grains | grains | grains |
| Untreated | — | 499 | 53 | 22 | 25 |
| Composition A | 0.5 | 875 | 79 | 7 | 13 |
| Sercadis ® + | 0.18 + 0.36 | 676 | 67 | 12 | 21 |
| Amistar ® | | | | | |

As clearly shown in Tables 5, 6, 7, 8 above, the treatment with the inventive Composition A is much more potent and effective than similar treatment with tank mix containing commercial compositions Sercadis®+Amistar®.

What is claimed is:

1. A concentrated agrochemical suspension comprising: 1) one or more active ingredients selected among SDHI fungicides and/or strobilurin fungicides; 2) stabilizing component comprising a) at least one naphthalenesulfonate condensate; b) at least one fatty alcohol alkoxylate; c) at least one block copolymer; d) optionally at least one organomodified polysiloxane; 3) water.

2. A concentrated agrochemical suspension comprising: 1) one or more active ingredients selected among SDHI fungicides and/or strobilurin fungicides; 2) stabilizing component comprising a) at least one naphthalenesulfonate condensate; b) at least one fatty alcohol alkoxylate; c) at least one block copolymer; d) at least one organomodified polysiloxane; 3) water.

3. The concentrated agrochemical suspension according to any one of claims 1-2, wherein the SDHI fungicides are selected from the group comprising benodanil, flutilanil, mepronil, isofetamid, fluopyram, fenfuram, carboxin, oxycarboxin, thifluzamide, benzovindiflupyr, bixafen, fluindapyr, fluxapyroxad, furametpyr, inpyrfluxam, isopyrazam, penflufen, penthiopyrad, sedaxane, isoflucypam, pydiflumetofen, boscalid, pyraziflumid and the mixtures thereof.

4. The concentrated agrochemical suspension according to any one of claims 1-3, wherein the SDHI fungicide is fluxapyroxad.

5. The concentrated agrochemical suspension according to any one of claims 1-2, wherein the strobilurin fungicides are selected from the group comprising azoxystrobin, kresoxim-methyl, picoxystrobin, fluoxastrobin, oryzastrobin, dimoxystrobin, pyraclostrobin, trifloxystrobin and the mixtures thereof.

6. The concentrated agrochemical suspension according to any one of claims 1-2, wherein the strobilurin fungicide is azoxystrobin.

7. A concentrated agrochemical suspension comprising: 1) at least one SDHI fungicide in an amount within the range from 1% to 70% by weight, more preferably from 5% to 60% by weight, and at least one strobilurin fungicide in an amount within the range from 1% to 70% by weight, more preferably from 5% to 60% by weight with respect to the weight of said concentrated agrochemical suspension; 2) stabilizing component comprising a) at least one naphthalenesulfonate condensate; b) at least one fatty alcohol alkoxylate; c) at least one block copolymer; d) optionally at least one organomodified polysiloxane; 3) water.

8. The concentrated agrochemical suspension according to claim 7, comprising fluxapyroxad and azoxystrobin.

9. The concentrated agrochemical suspension according to any one of claims 1-3, further comprising at least one additional fungicide selected from one of the following classes of compounds:
triazoles, imidazoles, copper salts, phthalimides, dithiocarbamates, chloronitriles, acylalanines.

10. The concentrated agrochemical suspension according to claim 9, wherein the overall concentration of at least one additional fungicide is in the range of from 1% to 40% by weight, with respect to the total weight of said agrochemical suspension.

11. The concentrated agrochemical suspension according to any one of claims 1-2, wherein the amount of the SDHI fungicide or strobilurin fungicide in the composition is about 1% to about 70% by weight, based on the total weight of the composition.

12. A method for controlling pathogens of fungal diseases in a crop plant comprising applying an effective amount of the composition comprising: 1) one or more active ingredients selected among SDHI fungicides and/or strobilurin fungicides; 2) stabilizing component comprising a) at least one naphthalenesulfonate condensate; b) at least one fatty alcohol alkoxylate; c) at least one block copolymer; d) optionally at least one organomodified polysiloxane; 3) water.

13. A method for controlling pathogens of fungal diseases in a crop plant comprising applying an effective amount of composition according to any one of claims 1-11 to a locus where the pest is to be controlled.

14. A method for controlling and/or preventing of fungal attack on soil, plant, tuber, fruit, root, foliage, seed, locus of the fungus, or a locus where fungal infestation is to be prevented, wherein the method comprises applying a fungicidally effective amount of the composition of any one of claims 1-11 to the soil, plant, tuber, fruit, roots, foliage, seed, locus of the fungus, or locus in which the infestation is to be prevented so as to thereby control and/or prevent fungal attack.

15. The method according to any one of claims 12-14, wherein the locus is a crop field.

16. The method according to any one of claims 12-15, wherein the crop is selected from the group consisting of rice, grapes and vegetables.

17. The method according to any one of claims 12-16, wherein the pathogens of fungal diseases are selected from Septoria species, Fusarium species, Puccinia species, Erisyphe species, Drechslera species, Ramularia species, Mycosphaerella species and Rhynchosporium species.

18. The method according to any one of claims 12-17, wherein the composition is applied in an amount from about 0.1 L/ha to about 5 L/ha.

19. Use of stabilizing component consisting of: a) at least one naphthalenesulfonate condensate; b) at least one fatty alcohol alkoxylate; c) at least one block copolymer; d) optionally at least one organomodified polysiloxane for increasing the efficacy of SDHI fungicides and/or strobilurin fungicides.

20. The use according to claim 19 wherein the SDHI fungicide is fluxapyroxad.

21. The use according to claim 19, wherein strobilurin fungicide is azoxystrobin.

22. Use of the stabilizing component consisting of: a) at least one naphthalenesulfonate condensate; b) at least one fatty alcohol alkoxylate; c) at least one block copolymer; d) at least one organomodified polysiloxane for increasing the efficacy of SDHI fungicides and/or strobilurin fungicides.

23. The use according to claim 22 wherein the SDHI fungicide is fluxapyroxad.

24. The use according to any one of claims 19-23, wherein strobilurin fungicide is azoxystrobin.

25. A method of control of crystal growth of SDHI fungicide in agrochemical suspension by addition of: a) at least one naphthalenesulfonate condensate; b) at least one block copolymer c) at least one organomodified polysiloxane to said agrochemical suspension comprising SDHI fungicide.

26. The method according to claim 25, wherein the SDHI fungicide is fluxapyroxad.
